(19) United States
(12) Patent Application Publication
(10) Pub. No.: US 2005/0141138 A1
(43) Pub. Date: Jun. 30, 2005

(54) Suspension, head gimbal assembly and disk drive apparatus with head gimbal assembly

(75) Inventors: Masashi Shiraishi, Kwai Chung (HK); Muneyoshi Kobashi, Kwai Chung (HK); Hiroyoshi Nakajima, Kwai Chung (HK)

Correspondence Address: BURNS DOANE SWECKER & MATHIS L L P, POST OFFICE BOX 1404, ALEXANDRIA, VA, 22313-1404, US

(73) Assignee: SAE MAGNETICS (H.K.) LTD.

(21) Appl. No.: 11/019,185

(22) Filed: Dec. 23, 2004

(30) Foreign Application Priority Data
Dec. 25, 2003 (JP) 429289/2003

(51) Int. Cl. G11B 5/60

(52) U.S. Cl. 360/234.5; 360/245.9

(57) ABSTRACT

A suspension includes a resilient flexure for adhering and supporting a head slider that has at least one head element, a load beam that supports said flexure, and a FPC member independently formed and fixed to the flexure and the load beam, having a plurality of connection pads electrically connected to the at least one head element and a plurality of trace conductors. One ends of the trace conductors are electrically connected to the plurality of connection pads, respectively. The FPC member has at least one slot formed at its face to which the head slider is adhered and located near the plurality of connection pads.

### PRIORITY CLAIM

This application claims priority from Japanese patent application No. 2003-429289, filed on Dec. 25, 2003, which is incorporated herein by reference.

### BACKGROUND OF THE INVENTION

1. Field of the Invention

The present invention relates to a suspension for supporting a flying type head slider with a head element such as a thin-film magnetic head element or an optical head element, to a head gimbal assembly (HGA), and to a disk drive apparatus with the HGA.

2. Description of the Related Art

A typical suspension used in a hard disk drive (HDD) apparatus has a structure provided with an integral-type trace conductor-flexure fabricated by forming in integral a thin-film trace conductor on a metal flexure, and with a load beam fixed to the integral-type trace conductor-flexure by laser-welding.

Recently, some suspensions have a structure with a cheap and small flexure, with a load beam fixed to the flexure by laser-welding, and with a discrete FPC (Flexible Print Circuit) member used in consumer electronic components and resin-adhered to the flexure and the load beam, without using the above-mentioned expensive integral-type trace conductor-flexure, as disclosed in U.S. Pat. No. 6,667,857. Because both such flexure and FPC member are cheap, the manufacturing cost of the suspension can be greatly reduced.

However, the suspension structure with such adhered FPC member disclosed in U.S. Pat. No. 6,667,857 has the following problem.

In general, fixing of a magnetic head slider to the suspension is performed by partially using a silver (Ag) paste in order to obtain electrical conduction between the magnetic head slider and the suspension, and by UV or thermally curing an ultra violet (UV) cure resin adhesive or an epoxy resin adhesive in order to secure the adhesion. These adhesives, however, may leak to connection pads used for electrical connection with the magnetic head slider and formed on the FPC member, and smear them. That is, because the AG paste contains Ag particles, if it is coated on the bottom surface of the magnetic head slider, the slider will somewhat lift from the FPC member. Thus, the FPC member has a step for pressing the AG paste to prevent the magnetic head slider from lifting. Although the resin adhesive is coated in this step of the FPC member, because the FPC member made of polyimide material has excellent stainless steel wettability and capillary phenomenon occurs at side edges of the magnetic head slider, a part of the resin adhesive may easily reach the connection pads located at the top end of the magnetic head slider. This reached adhesive causes contaminations of the connection pads.

If the amount of the resin adhesive used is extremely reduced to prevent such contaminations, the adhesion force will lower and at the worst the slider may be detached from the suspension.

In order to prevent such problems of contaminations and insufficient adhesion force, it is necessary to control in delicate the used amount of the resin adhesive and the location of its coating. This makes the adhesion process difficult and complicated.

### BRIEF SUMMARY OF THE INVENTION

It is therefore an object of the present invention to provide a suspension, HGA and a disk drive apparatus with the HGA, whereby the adhesion process can be simplified without inducing contaminations of connection pads.

Another object of the present invention is to provide a suspension, HGA and a disk drive apparatus with the HGA, whereby secured fixing of a magnetic head slider to the suspension can be expected.

According to the present invention, a suspension includes a resilient flexure for adhering and supporting a head slider that has at least one head element, a load beam that supports said flexure, and a FPC member independently formed and fixed to the flexure and the load beam, having a plurality of connection pads electrically connected to the at least one head element and a plurality of trace conductors. One ends of the trace conductors are electrically connected to the plurality of connection pads, respectively. The FPC member has at least one slot formed at its face to which the head slider is adhered and located near the plurality of connection pads.

Also, according to the present invention, an HGA includes the above-mentioned suspension and head slider.

Furthermore, according to the present invention, a disk drive apparatus with at least one HGA can be provided.

Because the FPC member has a slot that can prevent flowing of the adhesive, no adhesive reaches the connection pads without controlling in delicate the used amount of the adhesive and the location of its coating. This secures prevention of contaminations in the connection pads, and thus the adhesion process can be simplified. Furthermore, because enough amount of the adhesive can be used, secured fixing of the head slider to the suspension can be expected to provide a reliable HGA and disk drive apparatus.

It is preferred that the at least one slot includes at least one though slot penetrating the FPC member or at least one blind slot not penetrating the FPC member.

It is also preferred that the at least one slot includes a single slot running in a lateral direction of the head gimbal assembly. In this case, preferably, the single slot has a length longer than a total lateral width of the plurality of connection pads.

It is further preferred that the flexure and the load beam are formed by metal plate members, respectively.

It is preferred that the head slider is electrically conductive with the flexure by a conductive paste.

It is also preferred that the head slider is adhered to the flexure by a resin adhesive such as a thermal cure resin adhesive or a UV cure resin adhesive.

Further objects and advantages of the present invention will be apparent from the following description of the preferred embodiments of the invention as illustrated in the accompanying drawings.

### BRIEF DESCRIPTION OF THE SEVERAL VIEWS OF THE DRAWINGS

FIG. 1 shows an oblique view schematically illustrating main components of an HDD apparatus as a preferred embodiment according to the present invention;

FIG. 2 shows a plane view illustrating the whole structure of an HGA in the embodiment of FIG. 1;

FIGS. 3a, 3b, 3c and 3d show enlarged plane views illustrating a FPC member, a flexure, a flexure and a FPC member, and a top end section of the HGA, and

FIG. 4 shows a sectional view illustrating IV-IV line sectional view of FIG. 3d.

### DETAILED DESCRIPTION OF THE INVENTION

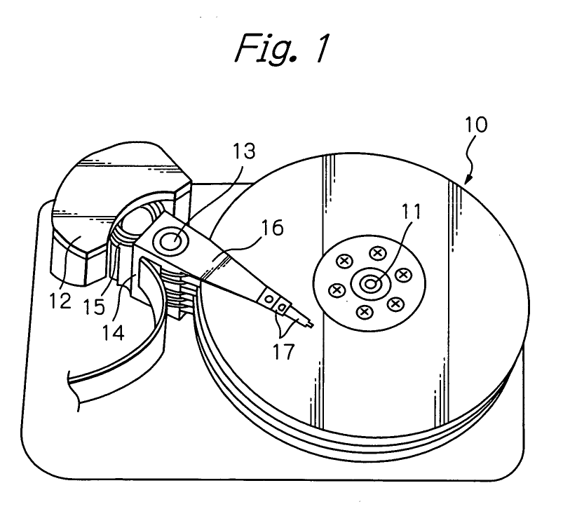

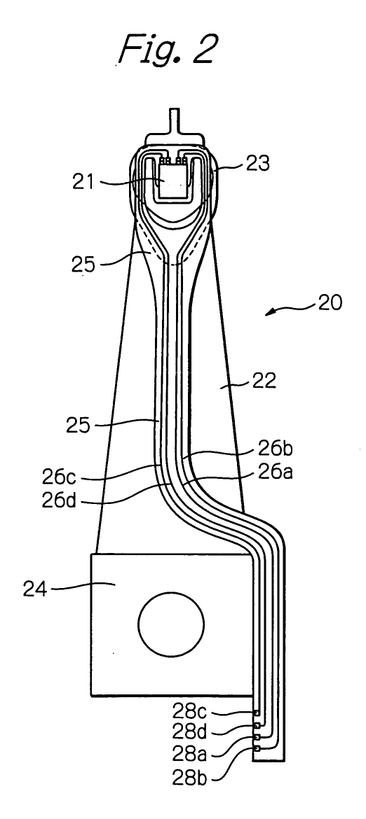

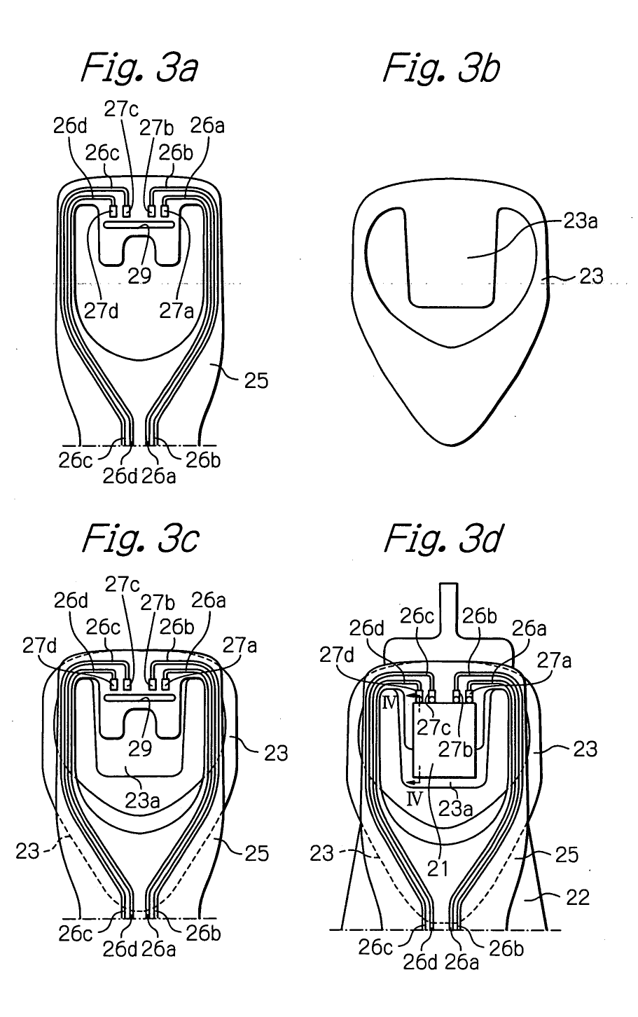

FIG. 1 schematically illustrates main components of an HDD apparatus as a preferred embodiment according to the present invention, FIG. 2 illustrates the whole structure of an HGA in this embodiment, and FIGS. 3a, 3b, 3c and 3d illustrate a FPC member, a flexure, a flexure and a FPC member, and a top end section of the HGA. More concretely, FIG. 3a illustrates only the FPC member, FIG. 3b illustrates only the flexure, FIG. 3c illustrates the combination of the flexure and the FPC member attached to the flexure, and FIG. 3d illustrates the HGA with the load beam, the flexure and the FPC member attached to the load beam, and a magnetic head slider mounted on the FPC member and the flexure.

In FIG. 1, reference numeral 10 denotes a plurality of magnetic hard disks rotating around an axis 11, and 12 denotes an assembly carriage device for positioning each magnetic head slider on a track of each disk. The assembly carriage device 12 is mainly constituted by a carriage 14 capable of rotating around an axis 13 and a main actuator 15 such as for example a voice coil motor (VCM) for driving the carriage 14 to rotate.

Base sections at one ends of a plurality of drive arms 16 stacked along the axis 13 are attached to the carriage 14, and one or two HGAs 17 are mounted on a top section at the other end of each arm 16. Each of the HGAs 17 has the magnetic head slider mounted at its top end section so that the slider opposes to a surface (recording and reproducing surface) of each of the magnetic disks 10.

As shown in FIGS. 2 and 3d, the HGA is assembled by fixing the magnetic head slider 21 with a magnetic head element to a top end section of a suspension 20.

The suspension 20 is substantially formed by the load beam 22, the resilient flexure 23 attached to the top end section of the load beam 22, a base plate 24 fixed to the rear end section of the load beam 22, and the FPC member or a wiring member 25.

The load beam 22 is made of in this embodiment a resilient stainless steel plate such as SUS304TA for example so as to produce a load force for pressing the magnetic head slider 21 through the flexure 23 toward the direction of a magnetic disk surface in operation.

The flexure 23 has, as clearly shown in FIG. 3b, a flexible tongue 23a with a proper stiffness, depressed by a dimple (not shown) formed on the load beam 22. On the tongue 23a, fixed is the magnetic head slider 21 via the FPC member 25. This flexure 23 has elasticity for supporting flexibly the magnetic head slider 21 by this tongue 23a and is made of in this embodiment a stainless steel plate such as for example SUS304TA. The flexure 23 is fixed with the load beam 22 at a plurality of points by pinpoint welding.

The base plate 24 to be attached to the drive arm 16 shown in FIG. 1 is made of in this embodiment a stainless steel or iron plate. This base plate 24 is fixed to the base section of the load beam 22 by welding.

On the load beam 22 and the flexure 23, the FPC member 25 independently formed and provided with the same structure as that used in consumer electronic components is adhered. This FPC member 25 has a base insulation material layer made of a resin material such as polyimide, a plurality of patterned trace conductors 26a-26d formed on the base insulation material layer, and a cover insulation material layer made of a resin material such as polyimide coated over the trace conductors and the base insulation material layer.

One ends of the trace conductors 26a-26d are electrically connected to head element connection pads 27a-27d formed at the top end section of the FPC member 25, respectively. The connection pads 27a-27d are electrically connected to terminal electrodes of the magnetic head slider 21 by gold (Au) ball bonding or solder ball bonding, for example. The other ends of the trace conductors 26a-26d are electrically connected to external circuit connection pads 28a-28d formed at the rear end section of the FPC member 25 and used for connection with an external circuit.

As shown in FIGS. 3a and 3c, according to this embodiment, particularly, a single groove or slot 29 running in a lateral direction of the suspension 20 or a direction traversing the axis of the suspension 20 is formed in the FPC member 25. This slot 29 is a through slot penetrating the FPC member 25 or a blind or recessed slot, and located in a near and rearward position of the connection pads 27a-27d but in a frontward position of the adhered section of the magnetic head slider 21, that is in a position between the connection pads 27a-27d and the adhered section of the magnetic head slider 21. The length of the slot 29 is longer than the total lateral width of the connection pads 27a-27d.

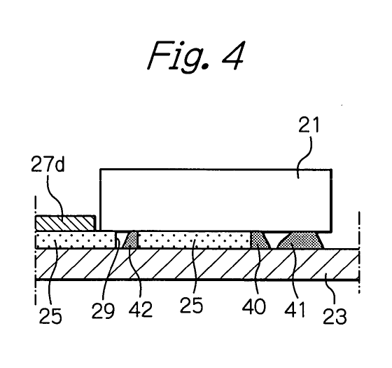

FIG. 4 illustrates IV-IV line sectional view of FIG. 3d.

As shown in the figure, because such slot 29 is formed in the FPC member 25, when the magnetic head slider 21 is electrically conducted with the flexure 23 by supplying a conductive paste 40 such as Ag paste and the magnetic head slider 21 is fixed to the flexure 23 by dropping and curing a resin adhesive 41 such as a thermal cure resin adhesive or a UV cure resin adhesive, excess resin adhesive 42 will stay in the slot 29 but never reach the region of the connection pad 27d even if relatively high amount of the adhesive is supplied. That is, no resin adhesive reaches the head element connection pads without controlling in delicate the used amount of the resin adhesive and the location of its coating. This secures prevention of contaminations in the connection pads, and thus the adhesion process can be simplified. Furthermore, because enough amount of the resin adhesive can be used, secured fixing of the magnetic head slider to the suspension can be expected to provide a reliable HGA and disk drive apparatus.

In the aforementioned embodiment, the single slot running in the lateral direction is formed in the FPC member. However, the slot according to the present invention is not limited to such structure but any slot with any shape and/or any size can be adopted under the condition that this slot can prevent flowing of the resin adhesive to the connection pads. Furthermore, the number of the slot is not limited to one, but a plurality of slots may be formed in the FPC member.

The structure of the suspension according to the present invention is not limited to the aforementioned structure. Many widely different embodiments of the present invention may be constructed without departing from the spirit and scope of the present invention. It should be understood that the present invention is not limited to the specific embodiments described in the specification, except as defined in the appended claims.

1. A suspension comprising:
a resilient flexure for adhering and supporting a head slider that has at least one head element;
a load beam that supports said flexure; and
a flexible print circuit member independently formed and fixed to said flexure and said load beam, having a plurality of connection pads electrically connected to said at least one head element and a plurality of trace conductors, one ends of said trace conductors being electrically connected to said plurality of connection pads, respectively,
said flexible print circuit member having at least one slot formed at its face to which said head slider is adhered and located near said plurality of connection pads.

2. The suspension as claimed in claim 1, wherein said at least one slot includes at least one though slot penetrating said flexible print circuit member.

3. The suspension as claimed in claim 1, wherein said at least one slot includes at least one blind slot not penetrating said flexible print circuit member.

4. The suspension as claimed in claim 1, wherein said at least one slot includes a single slot running in a lateral direction of said suspension.

5. The suspension as claimed in claim 4, wherein said single slot has a length longer than a total lateral width of said plurality of connection pads.

6. The suspension as claimed in claim 1, wherein said flexure and said load beam are formed by metal plate members, respectively.

7. A head gimbal assembly comprising:
a head slider having at least one head element;
a resilient flexure that adheres and supports said head slider;
a load beam that supports said flexure; and
a flexible print circuit member independently formed and fixed to said flexure and said load beam, having a plurality of connection pads electrically connected to said at least one head element and a plurality of trace conductors, one ends of said trace conductors being electrically connected to said plurality of connection pads, respectively,
said flexible print circuit member having at least one slot formed at its face to which said head slider is adhered and located near said plurality of connection pads.

8. The head gimbal assembly as claimed in claim 7, wherein said at least one slot includes at least one though slot penetrating said flexible print circuit member.

9. The head gimbal assembly as claimed in claim 7, wherein said at least one slot includes at least one blind slot not penetrating said flexible print circuit member.

10. The head gimbal assembly as claimed in claim 7, wherein said at least one slot includes a single slot running in a lateral direction of said head gimbal assembly.

11. The head gimbal assembly as claimed in claim 10, wherein said single slot has a length longer than a total lateral width of said plurality of connection pads.

12. The head gimbal assembly as claimed in claim 7, wherein said flexure and said load beam are formed by metal plate members, respectively.

13. The head gimbal assembly as claimed in claim 7, wherein said head slider is electrically conductive with said flexure by a conductive paste.

14. The head gimbal assembly as claimed in claim 7, wherein said head slider is adhered to said flexure by a resin adhesive.

15. The head gimbal assembly as claimed in claim 14, wherein said resin adhesive is a thermal cure resin adhesive.

16. The head gimbal assembly as claimed in claim 14, wherein said resin adhesive is a ultra violet cure resin adhesive.

17. A disk drive apparatus having at least one head gimbal assembly, said at least one head gimbal assembly comprising:
a head slider having at least one head element;
a resilient flexure that adheres and supports said head slider;
a load beam that supports said flexure; and
a flexible print circuit member independently formed and fixed to said flexure and said load beam, having a plurality of connection pads electrically connected to said at least one head element and a plurality of trace conductors, one ends of said trace conductors being electrically connected to said plurality of connection pads, respectively,
said flexible print circuit member having at least one slot formed at its face to which said head slider is adhered and located near said plurality of connection pads.

18. The disk drive apparatus as claimed in claim 17, wherein said at least one slot includes at least one though slot penetrating said flexible print circuit member.

19. The disk drive apparatus as claimed in claim 17, wherein said at least one slot includes at least one blind slot not penetrating said flexible print circuit member.

20. The disk drive apparatus as claimed in claim 17, wherein said at least one slot includes a single slot running in a lateral direction of said head gimbal assembly.

21. The disk drive apparatus as claimed in claim 20, wherein said single slot has a length longer than a total lateral width of said plurality of connection pads.

22. The disk drive apparatus as claimed in claim 17, wherein said flexure and said load beam are formed by metal plate members, respectively.

23. The disk drive apparatus as claimed in claim 17, wherein said head slider is electrically conductive with said flexure by a conductive paste.

24. The disk drive apparatus as claimed in claim 17, wherein said head slider is adhered to said flexure by a resin adhesive.

25. The disk drive apparatus as claimed in claim 24, wherein said resin adhesive is a thermal cure resin adhesive.

26. The disk drive apparatus as claimed in claim 24, wherein said resin adhesive is a ultra violet cure resin adhesive.
